(19) United States
(12) Patent Application Publication
(10) Pub. No.: US 2021/0010907 A1
(43) Pub. Date: Jan. 14, 2021

(54) TIRE TESTING MACHINE

(71) Applicant: KABUSHIKI KAISHA KOBE SEIKO SHO (KOBE STEEL, LTD.), Hyogo (JP)

(72) Inventors: Takashi SUMITANI, Takasago-shi, Hyogo (JP); Yu SUMIMOTO, Takasago-shi, Hyogo (JP)

(73) Assignee: KABUSHIKI KAISHA KOBE SEIKO SHO (KOBE STEEL, LTD.), Hyogo (JP)

(21) Appl. No.: 16/979,492

(22) PCT Filed: Mar. 8, 2019
(86) PCT No.: PCT/JP2019/009246

§ 371 Date: Sep. 9, 2020

(30) Foreign Application Priority Data
Mar. 29, 2018 (JP) 2018-064488
Feb. 27, 2019 (JP) 2019-034271

(51) Int. Cl. G01M 17/02; G01M 1/02

(52) U.S. Cl. CPC G01M 17/021; B60C 19/00; G01M 17/022; G01M 1/02

(57) ABSTRACT

Provided is a tire testing machine including a tire stripper capable of separating the tire from the upper rim well. The tire stripper includes first and second pressing mechanisms pressing the tire downward, a linking mechanism linking the first and second pressing mechanisms so as to cause them to move in directions of coming close to or separating from each other while keeping a mutually symmetrical positional relationship across the upper spindles radially thereof, and a positioning mechanism operating the linking mechanism to allow the first and second pressing mechanisms to be positioned.

### TECHNICAL FIELD

The present invention relates to a tire testing machine including a tire stripper for removing a tire from a rim.

### BACKGROUND ART

Conventionally, there has been known a tire testing machine capable of automatically testing a plurality of tires having mutually different inner circumferential diameters or tread surface widths (for example, refer to Patent Document 1).

Specifically, the tire conveyed from a lubrication section for a preceding process to a tire testing section is held between an upper rim mounted on an upper spindle and a lower rim mounted on a lower spindle, and air is fed into the tire. Thereafter, a load is applied to the tire to measure tire uniformity and the like.

After such a tire test, the load that had been applied to the tire is released, and the tire and the lower rim are separated from each other while the upper spindle is raised and the belt conveyor is raised to apply an upward force to the tire. Furthermore, the tire testing machine as described above further includes a tire stripper for separating the tire from the upper rim, which presses the tire in the vicinity of the bead portion that is being close contact with the upper rim in a direction parallel to the rotational axis direction of the tire, when the belt conveyor is raised to separate the upper rim and the lower rim from each other, thereby removing the tire so as to strip the tire from the upper rim. The tire thus separated from the rim is conveyed to a marking section for a post-process, and “singular point” and the like that is obtained in the tire test are stamped on the tire.

Since the tire held between the upper rim and the lower rim makes close contact with the upper rim and the lower rim, a large force is required to remove the tire so as to strip the tire from the rim after the tire test. For this reason, in order to improve the stripping property of the tire in the lubrication section of the preceding process, a liquid having a good lubricity (lubricant) is applied to the bead portion of the tire in advance.

However, the tire may be hard to remove from the rim after the tire test even with application of lubricant to the bead portion; for this case, the tire stripper is used to separate the tire from the upper rim. Thus, the tire stripper plays a role of applying an auxiliary force to the tire upon removal of the tire from the upper rim after the tire test.

Specifically, in a manufacturing line where a tire having undergone a vulcanization process is directly carried into a tire testing machine, the tire is still in a state of heat, and even if a lubricant is applied to a bead portion, the tire may dry immediately, which generates a case of failing to obtain a sufficient lubricating effect.

In this case, the tire stripper for separating the tire from the upper rim plays a major role, being important to remove the that is being in close contact with the upper rim so as to strip it.

The tire stripper can apply a force to the tire for separating the tire from the upper rim by including at least one pressing mechanism (e.g., an air cylinder) for pressing downward the tire being in close contact with the upper rim; however, in a situation where the lubricant applied to the bead portion dries immediately as described above, a larger pressing force is required for separating the tire from the upper rim.

### CITATION LIST

### Patent Literature

Patent Document 1: Japanese Patent No. 6087172

### SUMMARY OF INVENTION

To apply a large pressing force to the tire as described above, it could be performed to dispose a first pressing mechanism and a second pressing mechanism at respective positions symmetrical to each other across the center axis of the tire to apply downward pressing forces simultaneously to the tire by the first and second pressing mechanisms. Furthermore, in order to cope with tires of various sizes to be subjected to tire test, it could be performed to provide first and second position changing mechanisms for moving horizontally the first and second pressing mechanisms, respectively, to change respective press positions, at which the first and second pressing mechanisms press the tire, by the first and second position changing mechanisms.

However, when variations in the movement amounts of the first and second pressing mechanisms caused by, for example, malfunction due to aging of the first and second position changing mechanisms render the positions of the first and second pressing mechanisms asymmetric, pressing down the tire by the first and second pressing mechanisms causes a bending moment to be applied to the upper rim. This bending moment may dismount the upper rim from the upper spindle against a holding force of a magnet, for example, incorporated in the upper spindle, or the like, by which force the upper rim is held. Besides, when the upper rim is firmly fixed to the upper spindle by, for example, bolts, the tire separated from the upper rim in an inclined posture by the bending moment may jump to a position deviated from a regular position, and furthermore may fall off from the belt conveyor.

It is an object of the present invention to provide a tire testing machine including a tire stripper for separating a tire from an upper rim, the tire stripper being capable of separating the tire from the upper rim reliably and smoothly.

Provided is a tire testing machine comprising: an upper spindle having a vertical axis; an upper rim to be mounted on a lower end of the upper spindle; a lower spindle having a vertical axis; a lower rim to be mounted on an upper end of the lower spindle; and a tire stripper that separates the tire from the upper rim after a test of the tire has been performed by holding the tire in a horizontally lying posture between the upper rim and the lower rim and rotating the tire. The tire stripper includes a first pressing mechanism and a second pressing mechanism that are disposed at respective positions symmetrical to each other in a radial direction of the spindle across the upper spindle and configured to press downward a sidewall surface of the tire to separate the tire downward from the upper rim, a link mechanism that links the first pressing mechanism and the second pressing mechanism to each other so as to cause the first pressing mechanism and the second pressing mechanism to move to come close to or go away from each other in the radial direction of the upper spindle while keeping a positional relationship symmetrical to each other across the upper spindle, and a positioning mechanism that operates the link mechanism to allow the first pressing mechanism and the second pressing mechanism to be positioned in the radial direction of the upper spindle.

### BRIEF DESCRIPTION OF DRAWINGS

FIG. 1 is a plan view of a tire testing machine according to an embodiment of the present invention.

FIG. 2 is a front view of the tire testing machine.

FIG. 3 is a side view of the tire testing machine from the inlet side.

FIG. 4 is a front view of a tire stripper of the tire testing machine.

FIG. 5 is a plan view of the tire stripper.

FIG. 6 is a plan view schematically showing the main components of the tire testing machine.

### DESCRIPTION OF EMBODIMENTS

Hereinafter, there will be described an embodiment of the tire testing machine 1 according to the present invention with reference to the drawings. The embodiment described below is an example of embodying the present invention, and the present invention is not limited to the examples.

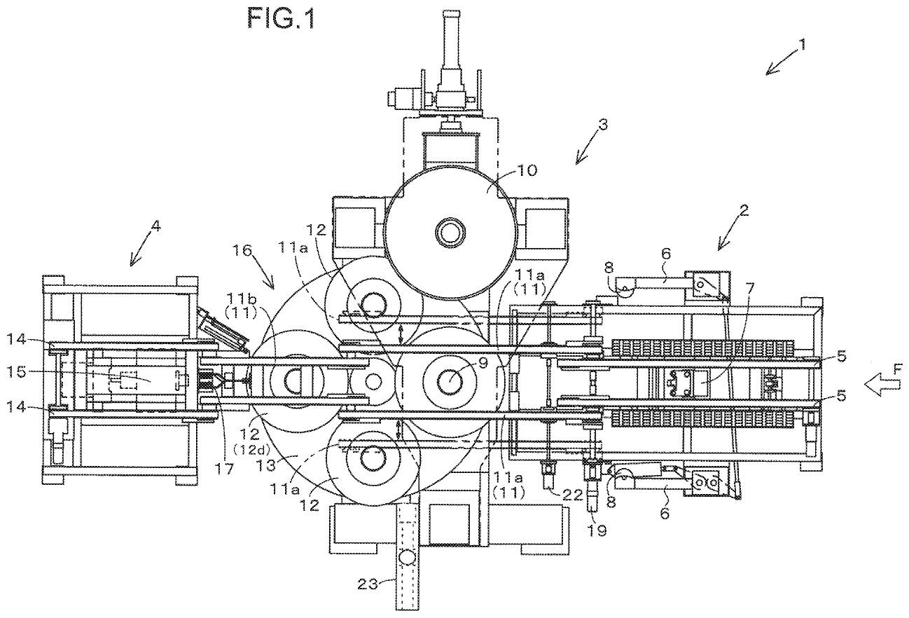

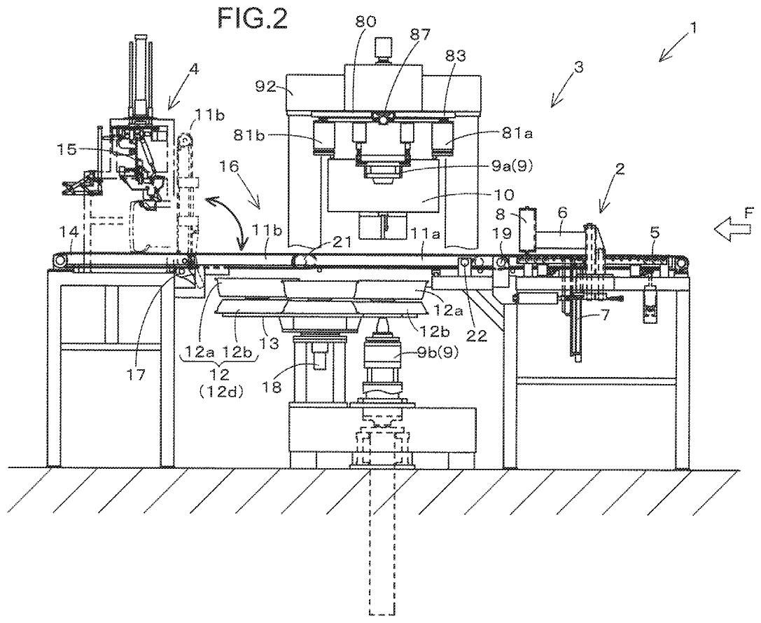

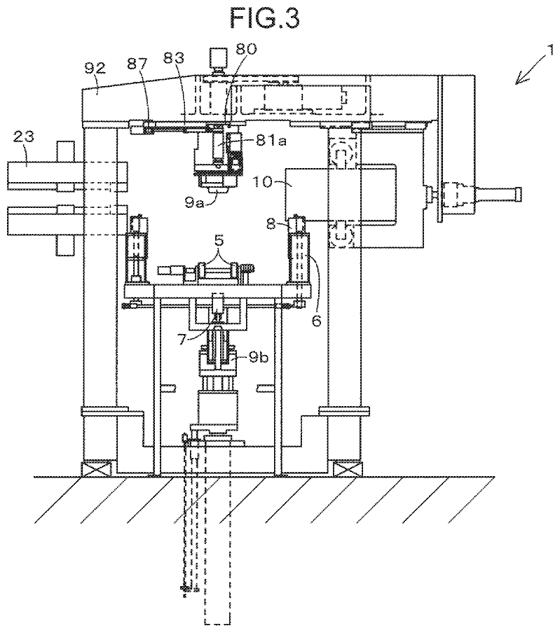

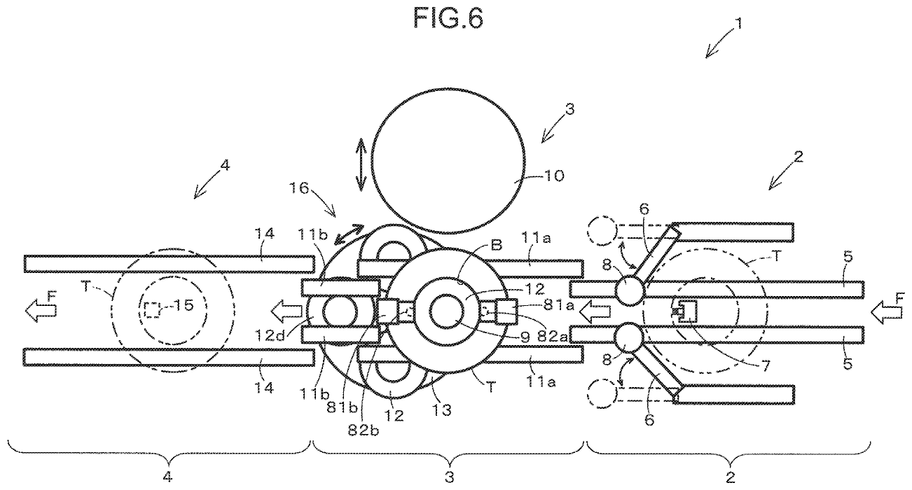

FIGS. 1 to 6 show a tire testing machine 1 according to the embodiment. In the following description of the tire testing machine 1, the length of a conveying path of a tire T in a conveying direction F of the tire T corresponds to the total length of the tire testing machine 1. The horizontal direction intersecting with the conveying direction F of the tire, more precisely the direction substantially perpendicular to the conveying direction F, corresponds to the depth direction of the tire testing machine 1. The depth direction is also referred to as a left-right direction or width direction.

The tire testing machine 1 includes a lubrication section 2, a tire testing section 3, and a marking section 4. The lubrication section 2 applies a lubrication liquid to the bead portion B of the tire T while rotating the tire T. The tire testing section 3 performs a tire test while rotating the tire T to which the lubrication liquid has been applied in the lubrication section 2 on a spindle, and detects a singular point that exists in the tire T. The marking section 4 applies marking on the circumferential position where the singular point exists in the tire T. The lubrication section 2, the tire testing section 3, and the front marking section 4 are aligned in this order from the upstream side toward the downstream side along the conveying path.

The lubrication section 2 includes a pair of left and right first conveyors 5 that convey the tire T in a posture in which the tire T is lying horizontally, a pair of right and left arm units 6 that hold therebetween the tire T carried in by the pair of first conveyors 5, and an application unit 7 that applies lubrication liquid to a bead portion B (inner peripheral edge) of the tire T held between the pair of arm units 6.

In this embodiment, each of the pair of first conveyors 5 is a belt conveyor having a conveying belt which is a loop-shaped strip forming an endless track.

Each of the pair of arm units 6 has a distal end, to which a rotary roller 8 is rotatably provided. The pair of arm units 6 sandwich the tire T conveyed from both the left and right outer sides to bring the rotary rollers 8 into contact with respective tread surfaces which are respective outer peripheral surfaces of the tire T. The rotary roller 8 rotates so as to allow the tire T to rotate about a vertical axis. The application unit 7, which is formed in a brush shape having a vertical central axis, rises to a position where the application unit 7 makes contact with the bead portion B of the tire T held by the pair of arm units 6 to apply the lubrication liquid to the bead portion B. After the application, the application unit 7 is returned to a position below the first conveyor 5 and stored there.

The pair of first conveyors 5 convey the tire T on which the lubrication liquid has been applied from the lubrication section 2 to the tire testing section 3.

The tire testing section 3 includes a spindle unit 9, a drum 10, a pair of left and right second conveyor units 11, a rim table 13, and a rim replacement mechanism 16.

The spindle unit 9 holds the tire T so as to allow the tire T to rotate about a vertical axis. The drum 10 has a cylindrical outer peripheral surface having a vertical central axis and is disposed on the side of the spindle unit 9 so as to be rotatable about the central axis.

The pair of second conveyor units 11 convey the tire T which has been conveyed from the lubrication section 2, in a posture in which the tire T lies horizontally. The rim table 13 has a rim placement surface allowing a plurality of rims 12 to be placed thereon. The rim replacement mechanism 16 replaces the rim 12 held by the spindle unit 9 with another rim.

In this embodiment, each of the pair of second conveyor units 11 is constituted by an upstream conveyor 11a and a downstream conveyor 11b disposed downstream of the upstream conveyor 11a with respect to the conveying direction. Each of the upstream and downstream conveyors 11a and 11b is a belt conveyor including a conveying belt which is a loop-shaped strip forming an endless track. In other words, the pair of second conveyor units 11 are constituted by a pair of the upstream conveyors 11a and a pair of the downstream conveyors 11b. The tire testing section 3 further includes a not-graphically-shown rotational driving unit that rotationally drives the spindle unit 9.

The tire testing machine 1 according to this embodiment further includes a grinder 23. The grinder 23 is disposed on the outlet side of the tire testing section 3 to shave a shoulder portion, which is a boundary portion between the tread surface and the sidewall of the tire T, when the result of the tire test exceeds the allowable value. The shape of the tire T is thereby adjusted to make the parameter of the tire T be within the allowable value of the measurement item of the tire test.

The tire T is held by the spindle unit 9 through the rim 12 rotatably about a vertical axis. The spindle unit 9 includes an upper spindle 9a and a lower spindle 9b. The upper spindle 9a and the lower spindle 9b are rod-shaped members rotatable about a common vertical axis. To hold the tire T so as to sandwich it at the upper and lower sides, each of the plurality of rims 12 is constituted by an upper rim 12a to be mounted on the lower end portion of the upper spindle 9a and a lower rim 12b to be mounted on the upper end portion of the lower spindle 9b. Specifically, the upper spindle 9a having a lower end portion on which the upper rim 12a is mounted and the lower spindle 9b having an upper end portion on which the lower rim 12b is mounted sandwich the tire T vertically to hold the tire T in a horizontally lying posture on the pair of second conveyor units 11 through the rim 12, thereby holding the tire T rotatably about axes of the upper and lower spindles 9a, 9b.

The rim table 13 is disposed in the vicinity of the lower spindle 9b, having the rim placement surface on which the plurality of rims 12 each including the upper rim 12a and the lower rim 12b that are stacked vertically can be placed.

The rim table 13 is made of a disk-shaped plate material. The tire testing section 3 further includes a rotational drive mechanism 18, which supports the rim table 13 rotatably about a vertical axis and is able to rotate the rim table 13. The rim table 13 is disposed so as to locate the rotational center axis thereof on the carry-out side (outlet side) of the lower spindle 9b. On the rim placement surface of the rim table 13, the plurality of rims 12 having different sizes from each other can be placed at respective positions (four positions in this embodiment) arranged in the circumferential direction. In each of the plurality of rims 12 placed on the rim table 13, the upper rim 12a and the lower rim 12b which can be mounted on the upper spindle 9a and the lower spindle 9b, respectively, are stacked. Thus, the rim table 13 according to the present embodiment is a rotary table.

The second conveyor units 11 are constituted by the pair of the upstream conveyors 11a and the pair of the downstream conveyors 11b. The upper spindle 9a is disposed above the upstream conveyors 11a and the lower spindle 9b is disposed below the upstream conveyors 11a. The conveyed tires T are tested, therefore, on the upstream conveyors 11a.

The tire testing section 3 further includes a slide mechanism 22. The slide mechanism 22 supports the pair of upstream conveyors 11a so as to allow the pair of upstream conveyors 11a to slide in a direction in which they are come close to and separate from each other in the left-right direction, and is able to slide the pair of upstream conveyors 11a. The slides in the direction in which the pair of upstream conveyors 11a come close to and separate from each other make it possible to remove the tire T from the lower rim 12b of the rim 12 and convey the tire T to the pair of downstream conveyors 11b corresponding to the tires T and the rims 12 having different sizes from each other.

The tire T is lowered with the lower spindle 9b after the test has been carried out thereon. At this time, if the interval between the pair of upstream conveyors 11a is being properly set, the lower spindle 9b can be lowered to a position below the pair of upstream conveyors 11a. This causes the tire T to be left on the pair of upstream conveyors 11a. The pair of upstream conveyors 11a, each being the belt conveyor, have both a function of allowing each of the tires T of various shapes to be removed from the lower rim 12b and conveyed to the pair of downstream conveyors 11b and a function of allowing the rim 12 to be taken out from the rim table 13 located below the pair of upstream conveyors 11a.

Specifically, the slides of the pair of upstream conveyors 11a in a direction of separating from each other to widen the interval between the pair of upstream conveyors 11a enables removal work and mounting work of the rim 12 to be performed. The removal work includes removing the upper rim 12a of the rim 12 from the upper spindle 9a and placing the upper rim 12a and the lower rim 12b of the rim 12 on the lower rim table 13 in a stacked state. The mounting work includes raising an upper rim 12a and a lower rim 12b in a stacked state in another rim 12 by the lower spindle 9b to mount the upper rim 12a on the distal end portion of the upper spindle 9a.

The tire testing section 3, thus, has an automatic rim changing function, which is a function of automatically changing the rim 12 to one that corresponds to the tire T carried in, based on information about the size of the tire T and the like, to thereby allow the tire test to be continued even when various sizes of tires T having different inner circumferential diameters or different widths of the tread surface or the like are carried in.

The tire testing machine 1 according to the present embodiment further includes the rim replacement mechanism 16 that enables the rim 12 placed on the rim table 13 to be replaced with another rim prepared outside. The rim replacement mechanism 16 includes the slide mechanism 22, the rotational drive mechanism 18, and a raising and lowering mechanism 17.

The raising and lowering mechanism 17, when the tire test is stopped, raises the pair of downstream conveyors 11b so as to separate the pair of downstream conveyors 11b from the pair of upstream conveyors 11a. The rotational drive mechanism 18 rotates the rim table 13 about a vertical axis to thereby move a replacement target rim 12d to be replaced among the plurality of rims 12 to a replacement position. The slide mechanism 22, when the tire test is stopped, slides the pair of upstream conveyors 11a in a direction intersecting the conveying direction F (in this embodiment, in the left-right direction).

The raising and lowering mechanism 17 raises respective downstream end portions of the pair of downstream conveyors 11b with respect to the conveying direction F and the slide mechanism 22 widens the interval between the pair of upstream conveyors 11a, whereby a space is formed on the carry-out side of the tire testing section 3. The replacement position of the replacement target rim 12d is set below the space. On the other hand, the drum 10 is disposed to allow the outer peripheral surface of the drum 10 to come into contact with and to separate from the tread surface of the tire T held by the spindle unit 9 radially of the tire T. The test of the tire T is performed by rotating the tire T at a predetermined number of revolutions while keeping the outer peripheral surface of the drum 10 in contact with the tread surface of the tire T. The drum 10 has a rotary shaft, to which a not-graphically-shown load cell is attached for measuring the force and moment applied from the rotating tire T to the drum 10.

Based on the result measured by the load cell, tire uniformity and the like are calculated, and the circumferential position and the axial position where the repulsive force of the tire T is the largest are each measured as a “singular point”. The tire test performed by the tire testing section 3 includes not only the above-described measurement of the tire uniformity but also a measurement of an outer shape and the like. The tire T where the “singular point” has been measured is rotated by a predetermined angle in the tire testing section 3, and then sent from the tire testing section 3 to the marking section 4.

The marking section 4 includes a pair of left and right third conveyors 14 and a mark stamping device 15. The pair of third conveyors 14 move the tire T in the conveying direction while keeping the tire T in a horizontally lying posture. The mark stamping device 15 applies marking on a predetermined position on the inner peripheral side of the tire T that is positioned on the pair of third conveyors 14. In this embodiment, each of the pair of third conveyors 14 is a belt conveyor having a conveying belt which is a loop-shaped strip forming an endless track.

For example, in the case of performing a tire test on the tire uniformity of the tire T in the tire testing section 3, the mark stamping device 15 applies a mark such as a uniformity mark indicating the “singular point” determined in the tire test on a circumferential position where the singularity of the tire uniformity exists in the tire T. In the case of performing a tire test for measuring the outer shape or the like, a mark other than the uniformity mark may be applied to the tire T.

After the tire test, performed is removal work of the tire, that is, the work to remove the tire T from the upper rim 12a and the lower rim 12b. Specifically, the lower spindle 9b on which the lower rim 12b is mounted is lowered, thereby allowing the tire T to be removed from the rim 12 and placed on the pair of upstream conveyors 11a.

At this time, it may be difficult to remove the tire T after the tire test from the upper rim 12a as described above. For this case, the tire testing machine 1 further includes a tire stripper 80, which is auxiliary used to remove the tire from the rim 12.

In the tire testing machine 1, the upper spindle 9a is fixed to the frame 92 of the ceiling portion so as to be restrained from moving at least vertically, while the lower spindle 9b is allowed to rise and fall. The tire stripper 80 strips the tire T from the upper rim 12a that is being in close contact with the tire T. Regarding the close contact between the lower rim 12b and the tire T, the tire T is stripped from the lower rim 12b when the spindle unit 9 is lowered beyond the upstream conveyor 11a.

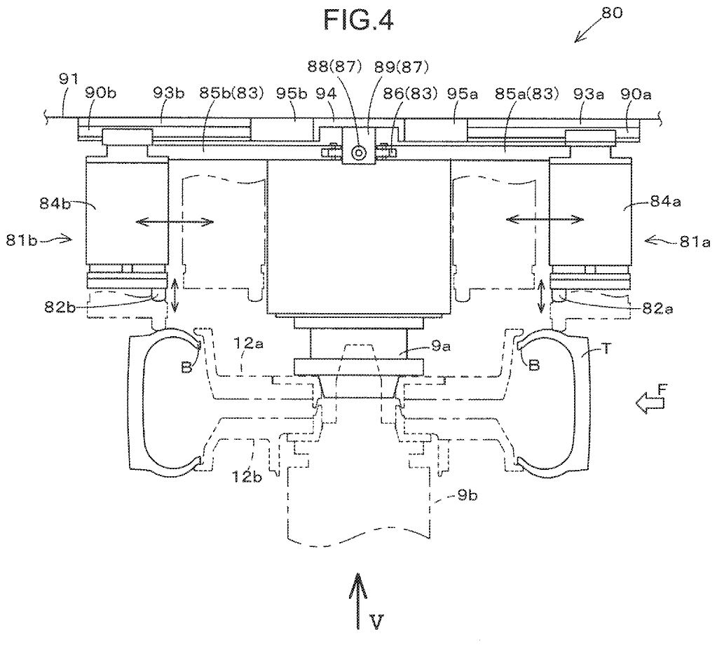

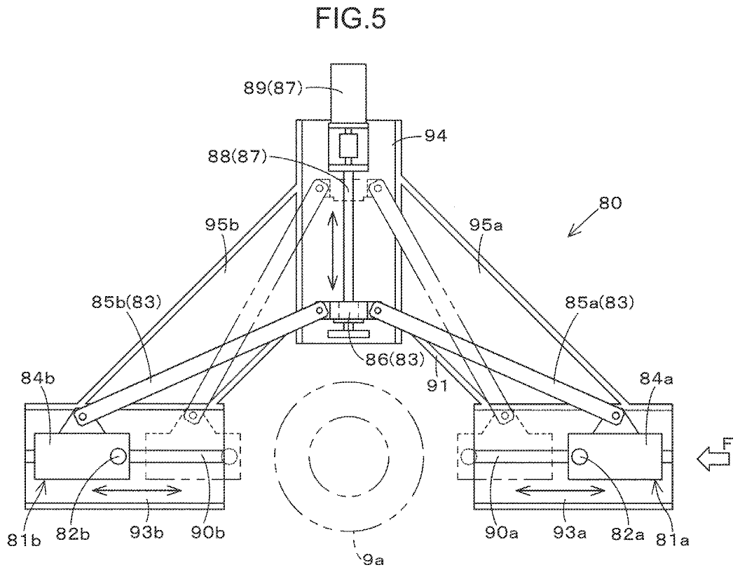

As shown in FIGS. 4 and 5, the tire stripper 80 according to the present embodiment is disposed in the vicinity of the upper spindle 9a. The tire stripper 80 presses downward the sidewall surface side of the tire T lying horizontally, i.e., in a horizontally lying posture, after the tire test to thereby separate the tire T from the upper rim 12a, thus playing an auxiliary role in the removal work of the tire T.

The tire stripper 80 includes a first pressing mechanism 81a and a second pressing mechanism 81b. The first and second pressing mechanisms 81a and 81b press downward the sidewall surface side portion of the tire T, preferably the bead portion B or a part near the bead portion B, thereby removing the tire T from the upper rim 12a. The first and second pressing mechanisms 81a, 81b are disposed at respective positions opposed to each other across the upper spindle 9a, in other words, respective positions circumferentially spaced by 180°. Each of the first and second pressing mechanisms 81and 82 according to this embodiment is composed of an air cylinder. Specifically, the first pressing mechanism 81 includes a first cylinder main body 84a and a first pressing portion 82a that moves relatively to the first cylinder main body 84a in the axial direction of the first cylinder main body 84a (vertically) below the first cylinder main body 84a. The second pressing mechanism 81b includes a second cylinder main body 84b and a second pressing portion 82b that moves relatively to the second cylinder main body 84b in the axial direction of the second cylinder main body 84b (vertically) below the second cylinder main body 84b.

The tire stripper 80 further includes a link mechanism 83 and a positioning mechanism 87. The link mechanism 83 links the first pressing mechanism 81a and the second pressing mechanism 81b to each other so as to cause the first and second pressing mechanisms 81a and 81b to move in a direction of coining close to or going away from each other in the radial direction of the upper spindle 9a while keeping mutually symmetrical positional relationship across the upper spindle 9a. The positioning mechanism 87 operates the link mechanism 83 to allow the first pressing mechanism 81a and the second pressing mechanism 81b to be positioned in the radial direction of the upper spindle 9a.

In the present embodiment, the first pressing mechanism 81a is disposed on the upstream side (carrying-in side) of the upper spindle 9a with respect to the conveying direction F, and the second pressing mechanism 81b is disposed on the downstream side (carrying-out side).

The link mechanism 83 includes a first pressing mechanism guide section, a second pressing mechanism guide section, a first link member 85a, a second link member 85b, and an inner connection member 86.

The first pressing mechanism guide section guides the first pressing mechanism 81a while supporting the first pressing mechanism 81a so as to limit the direction in which the first pressing mechanism 81a moves to a direction parallel to the radial direction of the upper spindle 9a, namely, a first movement direction (in this embodiment, the direction parallel to the conveying direction F). Similarly, the second pressing mechanism guide section guides the second pressing mechanism 81b while supporting the second pressing mechanism 81b so as to limit the direction in which the second pressing mechanism 81b moves to a direction parallel to the radial direction of the upper spindle 9a, namely, a second movement direction (in this embodiment, the direction parallel to the conveying direction F). Details of the first and second pressing mechanism guide sections will be described later.

The first link member 85a has a first proximal end portion and a first distal end portion opposite thereto. The first distal end portion forms a first outer connection portion, which is connected to a predetermined portion (in the example shown in FIG. 4, an upper end portion) of the first pressing mechanism 81a so as to be movable relatively to the first pressing mechanism 81a and rotationally about a first outer rotation axis (in this embodiment, a vertical axis) perpendicular to the first movement direction. The first proximal end portion forms a first inner connection portion located closer to the upper spindle 9a than the first outer connection portion with respect to the first movement direction (located on the left side in FIGS. 4 and 5).

The second link member 85b has a second distal end portion and a second proximal end portion opposite thereto. The second distal end portion forms a second outer side connection portion, which is connected to a predetermined portion (in the example shown in FIG. 4, an upper end portion) of the second pressing mechanism 81b so as to be movable relatively to the second pressing mechanism 81b and rotatably about a second outer rotation axis (in this embodiment, a vertical axis) perpendicular to the second movement direction. The second proximal end portion forms a second inner connection portion located closer to the upper spindle 9a than the second outer connection portion with respect to the second movement direction (located on the right side in FIGS. 4 and 5).

The inner connection member 86 is connected to the first proximal end portion of the first link member 85a and the second proximal end portion of the second link member 85b, respectively, so as to be relatively movable rotationally about an inner rotation axis parallel to the first outer rotation axis and the second outer rotation axis (in this embodiment, a vertical axis), thereby connecting the first proximal end portion and the second proximal end portion to each other.

As shown in FIG. 5, the first link member 85a is formed of a long rod material and interposed between the inner connection member 86 and the first pressing mechanism 81a. The first link member 85a has a length larger than the distance between the center of the spindle unit 9 and the most distal position of the first pressing mechanism 81a from the center of the spindle unit 9, with respect to the direction along the conveying direction F. In other words, the length of the first link member 85a, with respect to a direction perpendicular to the conveying direction F, is greater than the distance between the proximal end portion of the below-described rod portion 88 and the first pressing mechanism 81a.

The first proximal end portion of the first link member 85a moves with the inner connection member 86 along a linear track perpendicular to the conveying direction F. The linear track is a track along a straight line which is perpendicular to the first and second movement directions and intersects the center axis of the upper spindle 9a. Along with this movement, the first distal end portion of the first link member 5a moves with the first pressing mechanism 81a in the first movement direction (in this embodiment, in a direction along the conveying direction F).

Similarly to the first link member 85a, the second link member 85b is formed of a long rod material, having substantially the same length as the length of the first link member 85a, and interposed between the inner connection member 86 and the second pressing mechanism 81b. The second link member 85b has a length larger than the distance between the center of the spindle unit 9 and the most distal position of the second pressing mechanism 81b from the center of the spindle unit 9, with respect to the direction along the conveying direction F. In other words, the length of the second link member 85b, with respect to a direction perpendicular to the conveying direction F, is greater than the distance between the proximal end portion of the rod portion 88 and the position of the second pressing mechanism 81b.

The second proximal end portion of the second link member 85b moves with the inner connection member 86 along the linear track. Along with this movement, the second distal end portion of the second link member 85b moves with the second pressing mechanism 81b in the second movement direction this embodiment, a direction along the conveying direction F).

The tire testing machine according to this embodiment further includes a support member 91 as shown in FIG. 5. The support member 91 includes a first pressing mechanism storage section 93a that stores the first pressing mechanism 81a, a second pressing mechanism storage section 93b that stores the second pressing mechanism 81b, a positioning mechanism storage section 94 that stores the positioning mechanism 87, and a first interconnection section 95a and a second interconnection section 95b that interconnect the first and second pressing mechanism storage sections 93a, 93b and the positioning mechanism storage section 94, respectively. The entire support member 91 is a housing V-shaped in plan view. The storage sections 93a, 93b, 94 are radially arranged, each extending in a direction parallel to the radial direction of the spindle unit 9 and passing through the central axis of the spindle unit 9. In other words, the spindle unit 9 is surrounded by the storage sections 93a, 93b, and 94 in plan view as shown in FIG. 5.

The first pressing mechanism storage section 93a forms the first pressing mechanism guide section of the link mechanism 83, including a first guide rail 90a. The first guide rail 90a guides the first pressing mechanism 81a while supporting the first pressing mechanism 81a so as to limit the movement direction of the first pressing mechanism 81a to the first movement direction along the conveying direction F. The second pressing mechanism storage section 93b forms the second pressing mechanism guide section of the link mechanism 83, including a second guide rail 90b. The second guide rail 90b guides the second pressing mechanism 81b while supporting the second pressing mechanism 81b so as to limit the movement direction of the second pressing mechanism 81b to the second direction along the conveying direction F.

Each of the first and second guide rails 90a, 90b has a length capable of allowing the first and second pressing mechanisms 81a, 81b to move between the innermost position and the outermost position. The innermost position is a position where the first and second pressing mechanisms 81a, 81b can press the proper parts of the tire T having a minimum inner diameter of the plurality of types of tires T to be the target of the tire test, being the closest position to the spindle unit 9. The outermost position is a position where the first and second pressing mechanisms 81a, 81b can press the proper parts of the tire T having a maximum inner diameter of the plurality of types of tires T, being the farthest position from the spindle unit 9.

The first link member 85a and the second link member 85b in the link mechanism 83 are interconnected through the inner connection member 86, forming a V-shape on a horizontal plane (butterfly shape). The positioning mechanism 87 is connected to the inner connection member 86 to move the inner connection member 86 along the linear track. In this embodiment, the angle formed between the first link member 85a and the second link member 85b when the first and second pressing mechanisms 81a, 81b are located at the outermost position as indicated by a solid line in FIG. 5, that is, at the position for separating the tire T having the maximum inner diameter from the upper rim 12a, is, for example, approximately 80°. On the other hand, the angle formed between the first link member 85a and the second link member 85b when the first and second pressing mechanisms 81a, 81b are located at the innermost position as indicated by a two-dot chain line in FIG. 5, i.e., at the position for removing the tire T having the minimum inner diameter from the upper rim 12a, is, for example, approximately 30°.

The positioning mechanism 87 moves the inner connection member 86 along the linear track, that is, a track in the form of a straight line which is perpendicular to the first and second movement directions and intersects the center axis of the upper spindle 9a, to thereby swing the first and second link members 85a and 85b around the first and second outer rotation axes and the first and second inner rotation axes (in this embodiment, around the vertical axis) through the inner connection member 86, thereby moving the first and second pressing mechanisms 81a and 81b connected to the first and second distal end portions of the first and second link members 85a and 85b simultaneously in the reverse directions to each other along the first and second movement directions and at the same speed. Accordingly, by stopping this movement at an appropriate position can be performed the positioning of the first and second pressing mechanisms 81a and 81b, more specifically, determination of respective pressing positions at which the first and second pressing mechanisms 81a and 81b press the tire T.

The positioning mechanism 87 of the present embodiment includes a rod portion 88, a drive unit 89, and a not-graphically-shown screw nut. The rod portion 88 is a screw shaft having an outer peripheral surface formed with a male screw, opposite ends thereof being supported, in a posture where the rod portion 88 extends along the linear track, so as to be rotatable about the central axis of the rod portion 88 by the positioning mechanism storage section 94. The drive unit 89 is formed of a motor, being supported by the positioning mechanism storage section 94 and connected to the rod portion 88 to rotate the rod about the central axis. The screw nut has an inner circumferential surface formed with a female screw that is screwable with the male screw of the rod portion 88, being fixed to the inner connection member 86 to move along the linear track integrally with the inner connection member 86, along with the rotation of the rod portion 88, while sliding on the outer peripheral surface of the rod portion 88. As the positioning mechanism 87 according to the present embodiment, adopted is a so-called “trapezoidal screw mechanism”.

When the first and second pressing mechanisms 81a and 81b press the tire T, component forces along the first and second movement directions are generated because the parts pressed in the tire T are not horizontal. The component forces generate a torque to rotate the rod portion 88 about the central axis thereof. The drive unit 89 formed of the motor is provided with a brake for generating a brake torque to keep the rod portion 88 in a stationary state against the torque, and, furthermore, respective frictions given to the rod portion 88 and the screw nut in the trapezoidal screw contribute to the stationary state of the rod portion 88, that is, the fixing of the positions of the first and second pressing mechanisms 81a, 81b.

The positioning mechanism 87 is disposed at a position opposed to the drum 10. The axis of the rod portion 88 extends in the direction perpendicular to the first and second movement directions that are respective movement directions of the first and second pressing mechanisms 81a, 81b, in this embodiment, the radial direction of the upper spindle 9a. Accordingly, as shown in FIG. 5, the positioning mechanism 87 moves the inner connection member 86 and the first and second proximal end portions of the first and second linking members 85a and 85b connected thereto along the linear track (in this embodiment, the track along a straight line extending horizontally and in the radial direction of the upper spindle 9a and extending perpendicularly to the first and second movement directions).

Specifically, the positioning mechanism 87 moves the inner connection member 86 in a direction in which the inner connection member 86 goes away from the upper spindle 9a along the linear track, in other words, comes close to the drive unit 89, to thereby pull the first and second proximal end portions of the first and second link members 85a, 85b in a direction in which the first and second proximal end portions come dose to the drive unit 89 along the first and second movement directions, thereby making the first and second pressing mechanisms 81a, 81b that are opposed to each other approach each other along the first and second guide rails 90a, 90b toward the radial center of the upper spindle 9a. The positioning mechanism 87, thus moving the first and second pressing mechanisms 81a and 81b along the first and second movement directions, respectively, allows the first and second pressing mechanisms 81a and 81b to be positioned, by stopping the movement of the first and second pressing mechanisms 81a and 81b at appropriate positions, at respective positions where the first and second pressing portions 82a and 82b of the first and second pressing mechanisms 81a and 81b should press the tire T having a small inner diameter, respectively, to separate the tire T diameter from the upper rim 12a.

Conversely, the positioning mechanism 87 moves the inner connection member 86 in a direction in which the inner connection member 86 comes close to the upper spindle 9a along the linear track to thereby push the first and second proximal end portions of the first and second link members 85a and 85b to move the first and second proximal end portions toward the upper spindle 9a, thereby making the first and second pressing mechanisms 81a and 81b that are opposed to each other go away from each other and from the radial center of the upper spindle 9a along the first and second guide rails 90a and 90b. The positioning mechanism 87, thus moving the first and second pressing mechanisms 81a and 81b outward along the first and second movement directions, respectively, allows the first and second pressing mechanisms 81a and 81b to be positioned, by stopping the movement of the first and second pressing mechanisms 81a and 81b at appropriate positions, at respective positions at which the first and second pressing portions 82a and 82b of the first and second pressing mechanisms 81a and 81b should press the tire T having a large inner diameter, respectively, to separate the tire T from the upper rim 12a.

In the present embodiment, the first and second interconnection sections 95a and 95b of the support member 91 extend obliquely so as to interconnect the positioning mechanism storage section 94, which is the positioning mechanism support section, and the first and second pressing mechanism storage sections 93a and 93b, which are the first and second pressing mechanism support sections, respectively, thereby configuring the first and second pressing mechanisms 81a and 81b, the link mechanism 83, and the positioning mechanism 87 as a single unit.

As described above, in the tire stripper 80 according to the present embodiment, the link mechanism 83 links the first and second pressing mechanisms (e.g., air cylinders) 81a, 81b for pressing the tire T to remove it from the upper rim 12a to each other, thereby allowing the pressing positions of the tire T that is pressed by the first and second pressing mechanisms 81a, 81b to be determined by a single positioning mechanism 87 that only moves the inner connection member 86 included in the link mechanism 83 along a predetermined linear track. The first and second pressing mechanisms 81a, 81b are arranged, for example, at a position close to the lubrication portion 2 and a position close to the marking section 4, respectively.

The tire stripper 80, having the above configuration, can be disposed in a small space. Besides, both of the first and second pressing mechanisms 81a, 81b can be positioned by a single positioning mechanism 87, which facilitates the adjustment and maintenance of the device.

The link mechanism 83, linking the first and second pressing mechanisms 81a and 81b to each other so as to cause the first and second pressing mechanisms 81a and 81b to keep their mutually symmetrical positional relationship across the upper spindle 9a, restrains a bending moment from acting on the upper rim 12a due to the pressing force applied by the first and second pressing mechanisms 81a and 81b, thereby restraining the upper rim 12a from failing off from the upper spindle 9a due to the bending moment. Besides, the first and second interconnection sections 95a and 95b of the support member 91, configuring the first and second pressing mechanisms 81a and 81b, the link mechanism 83, and the positioning mechanism 87 as a single unit, allows these mechanisms to be conveniently mounted on the frame or the like of the tire testing section 3.

It should be noted that the embodiment disclosed herein is to be considered in all respects as illustrative and not restrictive. In particular, in the embodiment disclosed this time, matters that are not explicitly disclosed, such as operating and working conditions, various parameters, dimensions of components, weights, volumes, and the like, do not depart from the range normally practiced by a person skilled in the art, and values that can be easily assumed by a person skilled in the art are adopted.

The first and second pressing mechanisms 81a and 81b are not limited to air cylinders. Although the link mechanism 83 and the first and second pressing mechanisms 81a and 81b according to the embodiment are arranged in a horizontal plane, the plane including them is not limited to a horizontal plane. The positioning mechanism 87 is not limited to the trapezoidal screw mechanism. This is just an example, and other mechanisms capable of performing similar operations may be employed.

As described above, there is provided a tire testing machine including a tire stripper for separating a tire from an upper rim, the tire stripper being capable of separating the tire from the upper rim reliably and smoothly.

Provided is a tire testing machine comprising: an upper spindle having a vertical axis; an upper rim to be mounted on a lower end of the upper spindle; a lower spindle having a vertical axis; a lower rim to be mounted on an upper end of the lower spindle; and a tire stripper that separates the tire from the upper rim after the test of the tire has been performed by holding the tire in a horizontally lying posture between the upper rim and the lower rim and rotating the tire. The tire stripper includes a first pressing mechanism and a second pressing mechanism that are disposed at respective positions symmetrical to each other in a radial direction of the spindle across the upper spindle and configured to press downward a sidewall surface of the tire to separate the tire downward from the upper rim, a link mechanism that links the first pressing mechanism and the second pressing mechanism to each other so as to cause the first pressing mechanism and the second pressing mechanism to move in a direction of coming close to or going away from each other in the radial direction of the upper spindle while keeping a positional relationship symmetrical to each other across the upper spindle, and a positioning mechanism that operates the link mechanism to allow the first pressing mechanism and the second pressing mechanism to be positioned in the radial direction of the upper spindle.

The tire stripper of the tire testing machine, having the above-described configuration, can be disposed in a small space. Besides, both of the first and second pressing mechanisms can be positioned by a single positioning mechanism, which facilitates the adjustment and maintenance of the devices. The link mechanism, linking the first and second pressing mechanisms to each other so as to cause the first and second pressing mechanisms to keep their mutually symmetrical positional relationship with each other across the upper spindle, restrains a bending moment from acting on the upper rim due to pressing forces applied by the first and second pressing mechanisms, thereby restraining the upper rim from falling off from the upper spindle due to the bending moment.

It is preferable that the link mechanism, for example, includes a first pressing mechanism guide section that guides the first pressing mechanism while supporting the first pressing mechanism so as to limit a direction in which the first pressing mechanism moves to a first movement direction parallel to the radial direction of the upper spindle, a second pressing mechanism guide section that guides the second pressing mechanism while supporting the second pressing mechanism so as to limit a direction in which the second pressing mechanism moves to a second movement direction parallel to the first movement direction, a first link member having a first outer connection portion connected to the first pressing mechanism so as to be movable relatively to the first pressing mechanism and rotationally about a first outer rotation axis in a direction perpendicular to the first movement direction and a first inner connection portion located closer to the upper spindle than the first outer connection portion with respect to the first movement direction, a second link member having a second outer connection portion connected to the second pressing mechanism so as to be movable relatively to the second pressing mechanism and rotationally about a second outer rotation axis parallel to the first outer rotation axis and a second inner connection portion located closer to the upper spindle than the second outer connection portion with respect to the second movement direction, and an inner connection member connected to the first inner connection portion and the second inner connection portion so as to be relatively movable rotationally about an inner rotation axis parallel to the first outer rotation axis and the second rotation axis to thereby interconnect the first inner connection portion and the second inner connection portion, and that the positioning mechanism is connected to the inner connection member so as to move the inner connection member along a linear track which is perpendicular to the first movement direction and the second movement direction and intersects the central axis of the upper spindle. The link mechanism allows the positioning of both the first and second pressing mechanisms to be simultaneously performed with a simple configuration in which the positioning mechanism moves the inner connection member of the link mechanism along the linear track.

Specifically, the positioning mechanism is preferably connected to the inner connection member so as to move the inner connection member in a direction in which the inner connection member goes away from the upper spindle along the linear track to make the first pressing mechanism and the second pressing mechanism that are opposed to each other approach the upper spindle along the first movement direction and the second movement direction, respectively, and so as to move the inner connection member along the linear track in a direction in which the inner connection member comes close to the upper spindle to thereby make the first pressing mechanism and the second pressing mechanism that are opposed to each other go away from the upper spindle along the first movement direction and the second movement direction, respectively. The above-described positioning is thereby possible.

The first link member and the second link member are preferably disposed in a posture where the linear track is parallel to the radial direction of the upper spindle.

The tire testing machine, preferably, further comprises: a positioning mechanism support section that supports the positioning mechanism; and an interconnection section that interconnects the first pressing mechanism support section, the second pressing mechanism support section, and the positioning mechanism support section to thereby configure the first pressing mechanism, the second pressing mechanism, the link mechanism, and the positioning mechanism as a single unit. This enables the first and second pressing mechanisms, the link mechanism, and the positioning mechanism to be conveniently mounted on a predetermined place in the tire testing machine.

1. A tire testing machine, comprising:
an upper spindle having a vertical axis;
an upper rim to be mounted on a lower end of the upper spindle;
a lower spindle having a vertical axis;
a lower rim to be mounted on an upper end of the lower spindle; and
a tire stripper that separates the tire from the upper rim after the test of the tire has been performed by holding the tire in a horizontally lying posture between the upper rim and the lower rim and rotating the tire, wherein
the tire stripper includes a first pressing mechanism and a second pressing mechanism that are disposed at respective positions symmetrical to each other in a radial direction of the spindle across the upper spindle and configured to press downward a sidewall surface of the tire to separate the tire downward from the upper rim, a link mechanism that links the first pressing mechanism and the second pressing mechanism to each other so as to cause the first pressing mechanism and the second pressing mechanism to move in a direction of coming close to or going away from each other in the radial direction of the upper spindle while keeping a positional relationship symmetrical to each other across the upper spindle, and a positioning mechanism that operates the link mechanism to allow the first pressing mechanism and the second pressing mechanism to be positioned in the radial direction of the upper spindle.

2. The tire testing machine according to claim 1, wherein the link mechanism includes a first pressing mechanism guide section that guides the first pressing mechanism while supporting the first pressing mechanism so as to limit a direction in which the first pressing mechanism moves to a first movement direction parallel to the radial direction of the upper spindle, a second pressing mechanism guide section that guides the second pressing mechanism while supporting the second pressing mechanism so as to limit a direction in which the second pressing mechanism moves to a second movement direction parallel to the first movement direction, a first link member having a first outer connection portion connected to the first pressing mechanism so as to be movable relatively to the first pressing mechanism and rotationally about a first outer rotation axis in a direction perpendicular to the first movement direction and a first inner connection portion located closer to the upper spindle than the first outer connection portion with respect to the first movement direction, a second link member having a second outer connection portion connected to the second pressing mechanism so as to be movable relatively to the second pressing mechanism and rotationally about a second outer rotation axis parallel to the first outer rotation axis and a second inner connection portion located closer to the upper spindle than the second outer connection portion with respect to the second movement direction, and an inner connection member connected to the first inner connection portion and the second inner connection portion so as to be relatively movable rotationally about an inner rotation axis parallel to the first outer rotation axis and the second rotation axis to thereby interconnect the first inner connection portion and the second inner connection portion, and wherein the positioning mechanism is connected to the inner connection member so as to move the inner connection member along a linear track which is perpendicular to the first movement direction and the second movement direction and intersects the central axis of the upper spindle.

3. The tire testing machine according to claim 2, wherein the first link member and the second link member are disposed in a posture where the linear track is parallel to the radial direction of the upper spindle.

4. The tire testing machine of claim 2, wherein the positioning mechanism is connected to the inner connection member so as to move the inner connection member along the linear track in a direction in which the inner connection member goes away from the upper spindle to make the first and second opposing pressing mechanisms approach the upper spindle along the first movement direction and the second movement direction, respectively, and so as to move the inner connection member along the linear track in a direction in which the inner connection member comes close to the upper spindle to make the first and second opposing pressing mechanisms go away from the upper spindle along the first movement direction and the second movement direction, respectively.

5. The tire testing machine according to claim 2, further comprising: a positioning mechanism support section that supports the positioning mechanism; and an interconnection section that interconnects the first pressing mechanism guide section, the second pressing mechanism guide section, and the positioning mechanism support section to thereby configure the first pressing mechanism, the second pressing mechanism, the link mechanism, and the positioning mechanism as a single unit.
